(19) United States
(12) Patent Application Publication
(10) Pub. No.: US 2023/0054817 A1
(43) Pub. Date: Feb. 23, 2023

(54) SLIDING MEMBER, FUSING DEVICE, AND IMAGE FORMING APPARATUS

(71) Applicant: SHARP KABUSHIKI KAISHA, Osaka (JP)

(72) Inventor: TOMOHIRO MAEDA, Osaka (JP)

(21) Appl. No.: 17/870,727

(22) Filed: Jul. 21, 2022

(30) Foreign Application Priority Data
Aug. 20, 2021 (JP) 2021-134725

(51) Int. Cl. G03G 15/20

(52) U.S. Cl. CPC G03G 15/2053; G03G 15/2064; G03G 2215/2035

(57) ABSTRACT

A fusing device thermally fuses a toner image formed on a sheet. The fusing device includes a sliding sheet having a sliding contact surface. The inner circumferential surface of a fusing belt comes into contact with and slides on the sliding contact surface. The sliding sheet has a fabric structure containing fluororesin fibers. The fluoroplastic fibers that are flattened by thermal pressure are disposed on the sliding contact surface, Thus, the sliding sheet has heat resistance.

### BACKGROUND OF THE INVENTION

### Field of the Invention

The present disclosure relates to a sliding member, a fusing device including the sliding member, and an image forming apparatus including the fusing device.

### Description of the Background Art

An image forming apparatus generally includes a fusing device, which fuses a toner image to a sheet. Specifically, as described in the conventional technique, the fusing device includes a fusing belt, which is a heating member, a pressure roller, which is a pressure member disposed in proximity to and opposite the fusing belt. The fusing device further includes a support member, a heating source (heater), and a backup member disposed inside the fusing belt. The fusing belt is an endless flexible belt and is maintained in a predetermined shape by the support member positioned inside to form a fusing nip between the fusing belt and the pressure roller. Here, the fusing belt is in contact with the support member and slides against the support member when the fusing belt rotates. The backup member applies back pressure so that the support member can withstand the pressure from the pressure roller The rotation of the fusing belt and the pressure roller causes a sheet with a transferred toner image to be introduced into and pass through the fusing nip. At this time, the sheet is heated by the fusing belt (heater) and pressed by the pressure roller to fix the toner image on the sheet.

As described above, when the fusing belt rotates, it slides against the support member. In other words, the fusing belt slides with the support member, and to prevent interference with the rotation of the fusing belt, the frictional force between the fusing belt and the support member should be small. For example, the conventional technique describes a sheet-like sliding member being formed on the sliding surface with a resin film tubular body corresponding to the above fusing belt in the pressure member corresponding to the above support member. This results in smooth rotation of the resin film tubular body (fusing belt). The conventional technique describes a sheet-like sliding member composed of a non-porous sheet whose sliding surface is composed of a heat resistant resin, disposed on a base material having an uneven surface, heated and pressurized into a laminate by using, as an adhesive agent, a fluororesin having a melting point equal to or lower than that of the heat-resistant resin comprising the non-porous sheet impregnating the base material. The conventional technique also states that a lubricant is disposed between the resin film tubular body (fusing belt) and the sheet-like sliding member.

However, the sheet-like sliding member described in the conventional technique has a problem of low durability. Therefore, when the image forming apparatus is operated, the sheet-like sliding member may readily break, requiring frequent maintenance.

Thus, for example; as described in the conventional technique, there has been proposed a sliding member formed into a woven fabric of fluororesin fibers. This sliding member achieves the effect of durability higher than that of a sliding member composed of fluororesin impregnated into a base material.

However, the sliding member described in the conventional technique has relatively large surface irregularities because the fluororesin fiber is woven into a fabric. That is, the surface roughness Ha of the sliding surface of the sliding member with the fusing belt is relatively large. Thus, during fusing, the unevenness of the sliding surface of the sliding member may affect the sheet (toner) via the fusing belt. That is, it was difficult to improve the image quality of the image formed on the sheet.

An object of the disclosure, which has been made in view of the above-mentioned circumstances, is to provide a sliding member, a fusing device, and an image forming apparatus that are highly durable and can achieve satisfactory image quality.

### SUMMARY OF THE INVENTION

A sliding member according to an aspect of the disclosure is a sliding member having heat resistance, comprising: a fabric structure containing fluororesin fiber, the fluororesin fiber being flattened by thermal pressure and disposed on a sliding contact surface.

This provides a sliding member having high durability and a sliding contact surface having less unevenness. A fusing device of an image forming apparatus including the sliding member is advantageous in that the quality of image formation is improved and durability is increased.

Flattening refers to a state of relatively small unevenness, rather than a state of no unevenness at all with some unevenness.

In the sliding member, the surface roughness Ra of the sliding contact surface may be 19 μm or less.

This provides a sliding member having high durability and a sliding contact surface having less unevenness. Thus, an image forming apparatus including a fusing device including the sliding member is advantageous in that the quality of image formation is improved and durability is increased.

A fusing device according to an aspect of the disclosure is a fusing device that thermally fuses a toner image formed on a recording medium, including a fusing rotary body; a heat source that heats the fusing rotary body; a pressurizing rotary body that comes into contact with an outer circumferential surface of the fusing rotary body to form a fusing nip between the fusing rotary body and the pressurizing rotary body, the pressurizing rotary body rotating the fusing rotary body; a sliding member having a sliding contact surface, an inner circumferential surface of the fusing rotary body coming into contact and sliding on the sliding contact surface; a fusing pad to which the sliding member is fixed; and a support member that supports the fusing pad, wherein the sliding member has a fabric structure containing fluororesin fiber, the fluororesin fiber flattened by thermal pressure is disposed on the sliding contact surface, and the sliding member has heat resistance.

Since this makes the sliding members more durable and the sliding contact surfaces less uneven, the durability of the fusing device can also be improved. Since the sliding contact surface is less uneven, there is less impact on the recording media, and the quality of the image formed on the recording media is improved.

In the fusing device, the sliding member may be thermo-compressed to the fusing pad via an adhesive layer.

In this way, the sliding member can be readily disposed on the fusing pad, and the fusing device can be readily manufactured.

The fusing device further may include a metal part disposed between the fusing pad and the sliding member, and the sliding member may be thermo-compressed to the metal part via an adhesive layer.

Thus, the metal part prevents the fusing pad from being damaged during the manufacturing of the fusing device or other processes. Since the metal part has high thermal conductivity; heat from the heat source can be efficiently transmitted, and the surface temperature of the fusing nip of the fusing rotary body can be made uniform.

In the fusing device, the adhesive layer may not e disposed on the sliding contact surface of the sliding member.

In this way, the retention of lubricant on the sliding contact surface is not inhibited by the adhesive layer, and the durability of the sliding member is further improved.

In the fusing device, the surface roughness Ra of the sliding contact surface of the sliding member may be 19 μm or less.

Since this enables the realization of a sliding member having high durability and less unevenness on the sliding contact surface, the durability of the fusing device is increased, and the quality of the image formed on the recording medium is improved.

An image forming apparatus according to an aspect of the disclosure includes the above fusing device.

In this way, the image forming apparatus is advantageous in that the durability is high and the quality of the image formed on the recording media is improved.

The disclosure can provide a sliding member, a fusing device, and an image forming apparatus that are highly durable and can achieve satisfactory image quality.

### BRIEF DESCRIPTION OF THE DRAWINGS

FIG. 1 is a schematic perspective diagram illustrating a cross-section of the configuration of an image forming apparatus according to a first embodiment of the disclosure.

FIG. 2 is a schematic sectional view of the configuration of a fusing device of the image forming apparatus according to the first embodiment of the disclosure.

FIG. 3A is a first process diagram illustrating a process of mounting a sliding sheet on a fusing pad of the image forming apparatus according to the first embodiment of the disclosure.

FIG. 3B is a second process diagram illustrating a process of mounting a sliding sheet on a fusing pad of the image forming apparatus according to the first embodiment of the disclosure.

FIG. 4 illustrates an example of a surface of a sliding sheet according to the first embodiment of the disclosure.

FIG. 5 is a schematic diagram illustrating a cross-section of the sliding sheet according to the first embodiment of the disclosure.

FIG. 6 is a schematic sectional view of the configuration of a fusing pad and a sliding sheet of an image forming apparatus according to a second embodiment of the disclosure.

FIG. 7A is a first process diagram illustrating a process of mounting a sliding sheet on a fusing pad of the image forming apparatus according to the second embodiment of the disclosure.

FIG. 7B is a second process diagram illustrating a process of mounting a sliding sheet on a fusing pad of the image forming apparatus according to the second embodiment of the disclosure.

FIG. 7C is a third process diagram illustrating a process of mounting a sliding sheet on a fusing pad of the image forming apparatus according to the second embodiment of the disclosure.

### DESCRIPTION OF THE PREFERRED EMBODIMENTS

The following describes embodiments of the disclosure with reference to the accompanying drawings. The same components in the following description are labeled with the same reference signs. The same components have the same name and the same function. Therefore, the detailed description thereof will not be repeated.

### First Embodiment

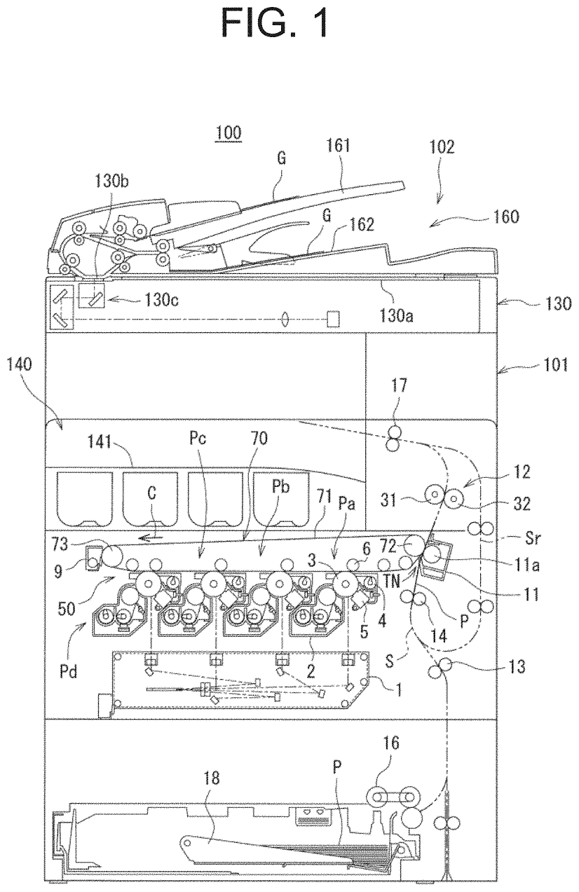

An image forming apparatus according to a first embodiment of the disclosure will be described below with reference to the drawings. FIG. 1 is a schematic perspective diagram illustrating a cross-section of the configuration of an image forming apparatus 100 according to the first embodiment of the disclosure.

As illustrated in FIG. 1, the image forming apparatus 100 is a multifunction peripheral having a copier function, a scanner function, a facsimile function, and a printer function to transmit an image of a document G read by an image reading device 102 to an external unit. The image forming apparatus 100 forms a color or monochrome image of the document G read by the image reading device 102 or an image received from an external unit on a sheet P of, for example, paper, which is a recording medium.

Above an image reader 130, a document feeder 160 (automatic document feeder (ADE)) is supported on the image reader 130 to freely open and close relative to the image reader 130. The image reading device 102 includes the document feeder 160. The document feeder 160 conveys a single document G or sequentially conveys multiple documents G one by one. The image reading device 102 reads the single document G conveyed by or the plurality of documents G sequentially conveyed one by one by the document feeder 160. The image reading device 102 includes a document loading table 130a on which the document G is loaded, and a loaded document reading function that reads the document G loaded on the document loading table 130a. In the image forming apparatus 100, when the document feeder 160 is open, the document loading table 130a above the image reader 130 is exposed so that the document G may be placed by hand. The document feeder 160 includes a document loading tray 161 on which the document G is loaded and a document discharge tray 162 on which the externally discharged document G is loaded. The image reading device 102 includes a conveyed document reading function that reads the document G conveyed by the document feeder 160. The document feeder 160 conveys the document G loaded on the document loading tray 161 to above a document reader 130b in the image reader 130, The image reader 130 scans a scanning optical system 130c to read the document loaded on the document loading table 130a or the document G conveyed by the document feeder 160, and generates image data.

An image forming apparatus body 101 includes an optical scanning device 1, a developing device 2, a photoconductor drum 3, a drum cleaning device 4, a charger 5, an intermediate transfer belt device 70, a secondary transfer device 11, a fusing device 12, a sheet conveyance path S, a sheet feed cassette 18, and a sheet discharge tray 141.

The image forming apparatus 100 handles image data corresponding to a color image using black (K), cyan (C), magenta (M), and yellow (Y) colors, or a monochrome image using a single color (e.g., black). An image transferer 50 of the image forming apparatus 100 includes developing devices 2, photoconductor drums 3, drum cleaning devices 4, and chargers 5, four each, for forming four types of toner images, each of which corresponds to black, cyan, magenta, and yellow, thereby configuring four image stations Pa, Pb, Pc, and Pd.

The optical scanning device 1 exposes the surface of each photoconductor drum 3 to form an electrostatic latent image. The corresponding developing device 2 develops the electrostatic latent image on the surface of the photoconductor drum 3 to form a toner image on the surface of the photoconductor drum 3. The corresponding drum cleaning device 4 removes and collects the residual toner on the surface of the photoconductor drum 3. The corresponding charger 5 uniformly charges the surface of the photoconductor drum 3 to a predetermined potential. These operations are performed sequentially to form the toner image of each color on the surface of each photoconductor drum 3.

The intermediate transfer belt device 70 includes intermediate transfer rollers 6, an endless intermediate transfer belt 71, an intermediate transfer driving roller 72, an intermediate transfer driven roller 73, and a cleaning device 9. Four intermediate transfer rollers 6 are disposed inside the intermediate transfer belt 71 to form four different toner images for the respective colors. The intermediate transfer rollers 6 transfers the toner image of the respective colors formed on the surfaces of the photoconductor drums 3 to the intermediate transfer belt 71, which rotationally moves in direction C.

The intermediate transfer bell 71 is stretched over the intermediate transfer driving roller 72 and the intermediate transfer driven roller 73. In the image forming apparatus 100, the toner images of the respective colors formed on the surfaces of respective photoconductor drums 3 are sequentially transferred and superimposed to form a color toner image on the surface of the intermediate transfer belt 71. The cleaning device 9 removes and collects residual toner that remains on the surface of the intermediate transfer belt 71 without being transferred to the sheet P.

The secondary transfer device 11 forms a transfer nip TN between a secondary transfer roller 11a and the intermediate transfer belt 71, and holds the sheet P conveyed through the sheet conveyance path S between the transfer nip TN and conveys the sheet P. The toner image on the surface of the intermediate transfer belt 71 is transferred onto the sheet P when the sheet P passes through the transfer nip TN, and the sheet P is conveyed to the fusing device 12.

The fusing device 12 includes a fusing belt 31 and a pressure roller 32 that rotate while sandwiching the sheet P. The fusing device 12 sandwiches, between the fusing belt 31 and the pressure roller 32, the sheet P on which the toner image has been transferred, heats and pressurizes the sheet P, and fuses the toner image to the sheet P. Although not illustrated in FIG. 1, the fusing device 12 includes components besides the fusing belt 31 and the pressure roller 32. Details of the fusing device 12 will be described below.

The sheet feed cassette 18 is a cassette that stores sheets P used for image formation and is disposed under the optical scanning device 1. The sheet P is pulled out of the sheet feed cassette 18 by a pickup roller 16 and is conveyed to the sheet conveyance path S. The sheet P conveyed to the sheet conveyance path S is conveyed to a discharge roller 17 via the secondary transfer device 11 and the fusing device 12, and is discharged to the sheet discharge tray 141 in a discharger 140. A conveyance roller 13, a registration roller 14, and the discharge roller 17 are disposed in the sheet conveyance path S. The conveyance roller 13 promotes the conveyance of the sheet P. The registration roller 14 temporarily stops the sheet P and aligns the leading edge of the sheet P. The registration roller 14 conveys the sheet P, which is once stopped, in timing with a color toner image on the intermediate transfer belt 1. The color toner image on the intermediate transfer belt 71 is transferred to the sheet Pin the transfer nip TN between the intermediate transfer belt 71 and the secondary transfer roller 11a.

Although the single sheet feed cassette 18 is provided in FIG. 1, this is not a limitation, and a configuration may be such that the sheet feed cassettes 18 are provided to store the different types of sheets P.

When an image is formed on the back side of the sheet P as well as the front side thereof, the image forming apparatus 100 conveys the sheet P in the reverse direction from the discharge roller 17 to a sheet reversal path Sr. The image forming apparatus 100 reverses the front and back of the sheet P conveyed in the reverse direction and leads the conveyed sheet P again to the registration roller 14. The image forming apparatus 100, in the same manner as the front face, also forms an image on the back face of the sheet P guided by the registration roller 14, and carries the sheet P out to the sheet discharge tray 141.

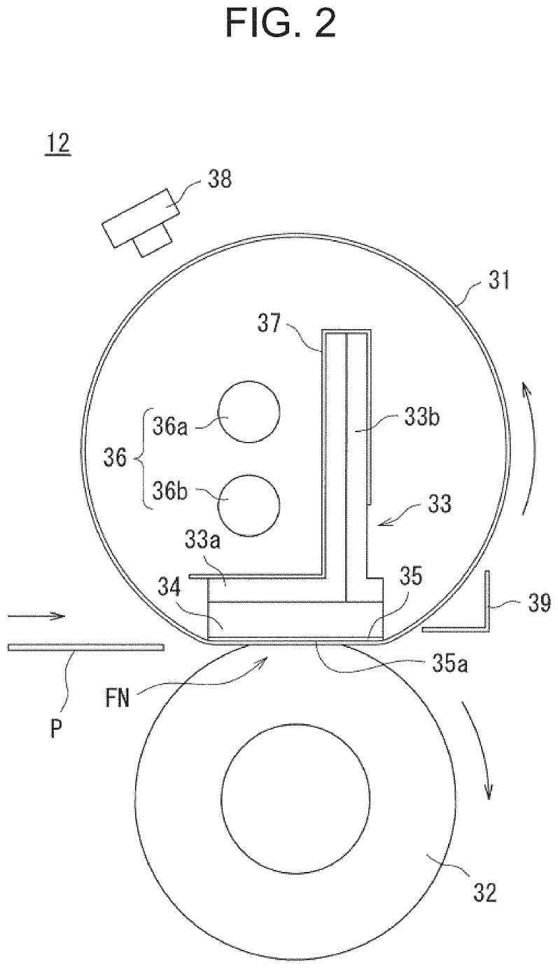

The configuration of the fusing device 12 will now be described in detail with reference to FIG. 2. FIG. 2 is a schematic sectional view of the configuration of the fusing device of the image forming apparatus according to the first embodiment of the disclosure.

The fusing device 12 includes the fusing belt 31 and the pressure roller 32, as described above. As illustrated in FIG. 2, the fusing device 12 has a support member 33, a fusing pad 34, a sliding sheet 35, a heat source 36, and a reflector 37, which are provided inside the fusing belt 31. The fusing device 12 also includes a temperature sensor 38 and a release plate 39.

The fusing belt 31 is a flexible endless belt and has a substantially annular shape. The fusing belt 31 has a configuration in which a release layer is provided on the surface of a belt-like base material composed of, for example, a synthetic resin, such as polyimide, or a metal, such as nickel. The fusing belt 31 is provided so as to be rotatable about a rotation axis extending along a direction perpendicular to the surface of the paper in FIG. 2. The inner diameter of the fusing belt 31 is, for example, 30 mm.

The fusing pad 34 is composed of, for example, resin and is formed as a long plate extending along the rotation axis direction of the fusing belt 31. The sliding sheet 35 is disposed on the outer circumferential surface (the face adjacent to the fusing belt 31) of the fusing pad 34. The length of the fusing pad 34 is substantially the same length as that of the fusing belt 31 in the rotation axis direction. The fusing pad 34 preferably has heat resistance, and may be, for example, a liquid crystal polymer or polyetheretherketone (PEEK).

The fusing pad 34 is fixed such that the sliding sheet 35 is in sliding contact with the inner circumferential surface of the fusing belt 31. That is, the fusing pad 34 is disposed such that a sliding contact surface 35a of the sliding sheet 35 is in contact with the inner circumference of the fusing belt 31. Although the fusing belt 31 rotates, the fusing pad 34 and the sliding sheet 35 are fixed to the fusing belt 31, and the fusing belt 31 slides on the sliding contact surface 35a. A sliding oil as a lubricant is applied to the sliding contact surface 35a of the sliding sheet 35 to reduce the frictional force with the fusing belt 31. The sliding oil is preferably a material having heat resistance and lubricity, and may be, for example, silicone oil, fluorine grease, or fluorine oil.

The sliding sheet 35 preferably has a small frictional force with the fusing belt 31 and has a fabric structure containing fluororesin fibers. More specifically, the sliding sheet 35 has a configuration in which fluororesin fibers are woven into a fabric. The sliding sheet 35 is not only made into a fabric by weaving fluororesin fibers, but also manufactured by applying pressure to at least the sliding contact surface 35a while being heated. As a result, the unevenness of the sliding contact surface 35a is reduced, and the surface roughness Ra is relatively small. The application of pressure while heating is referred to as thermal pressure. The surface roughness Ra of the sliding contact surface 35a is preferably 19 μm or less. When the surface roughness Ra of the sliding contact surface 35a is 19 μm or less, the quality of the image formed on the sheet P is satisfactory, and defects such as streaks in the image formed on the sheet P can be suppressed.

The fluororesin fibers used for the sliding sheet 35 may be, for example, polytetrafluoroethylene (PTFE) fibers. Examples of fluororesins other than PTFE include fluororesin fibers such as tetrafluoroethylene-6-fluoropropylene copolymer (FEP), ethylene tetrafluoride-perfluoroalkyl ether copolymer (PFA), and ethylene tetrafluoroethylene copolymer (EEFT). The method for producing the fluororesin fiber and the method for producing the fabric structure containing the fluororesin fiber before thermal pressing are not particularly limited, and may be a typical production method. The surface roughness Ra of a typical fluororesin fiber fabric structure before thermal pressing is approximately 22 μm.

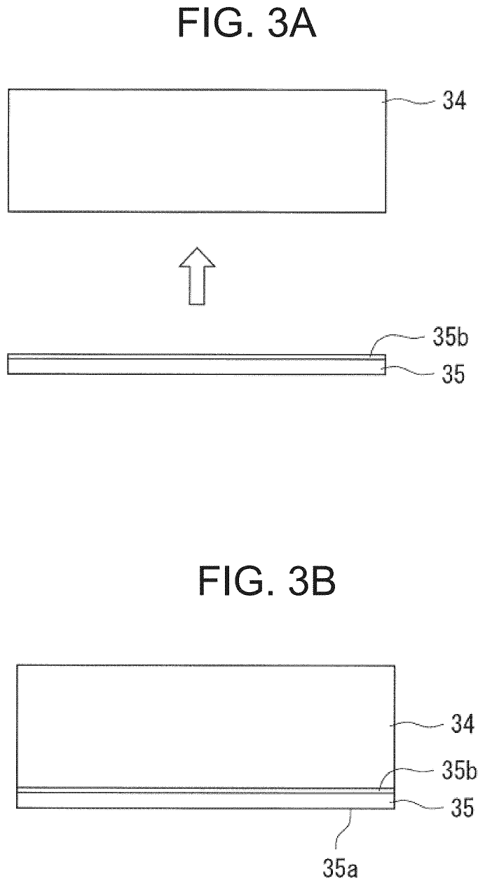

An adhesive layer 35b (see FIGS. 3A and 3B) may be provided on the surface remote from the sliding contact surface 35a of the sliding sheet 35, and the sliding sheet 35 may be pressed against the fusing pad 34 while being heated (under thermal pressure), to reduce (flatten) the surface roughness of the sliding contact surface 35a of the sliding sheet 35 and fix and adhere the sliding sheet 35 to the fusing pad 34. This allows the flattening of the sliding contact surface 35a and the fixing of the sliding sheet 35 to the fusing pad 34 at the same time, to simplify the manufacturing process of the fusing device 12 and reduce the manufacturing cost. The application of pressure while heating is referred to as thermo-compression. The details of the configuration of the sliding sheet 35 will be described below.

The support member 33 supports the fusing pad 34 (sliding sheet 35) while pressing the fusing pad 34 against the inner circumferential surface of the fusing belt 31, and the two ends of the support member 33 are fixed to a fusing frame (not illustrated). In the first embodiment, the support member 33 has a substantially L-shaped cross-section and has a long plate-shaped fixing part 33a to which the fusing pad 34 is fixed, and a long plate-shaped erected part 33h that is erected from the end of the fixing part 33a.

The reflector 37 covers the surface of the support member 33 adjacent to the heat source 36, and has a thin plate shape. The fusing belt 31 is efficiently heated by the reflector 37.

The heat source 36 is a member for heating the fusing belt 31, and extends along the rotation axis direction of the fusing belt 31 (in the direction perpendicular to the surface of the paper in FIG. 2). The heat source 36 is, for example, a lamp heater such as a halogen lamp. In the first embodiment, the heat source 36 includes a first lamp heater 36a that heats a central portion of the fusing belt 31 in the rotation axis direction, and a second lamp heater 36b that heats the two ends of the fusing belt 31 in the rotation axis direction. The operations of the first lamp heater 36a and the second lamp heater 36b are determined in accordance with the size of the sheet P. The heat source 36 heats the fusing belt 31 to, for example, 130° C. to 180° C. Thus, it is preferable that not only the fusing belt 31, but also the sliding sheet 35, etc., have heat resistance to the above temperatures.

The pressure roller 32 opposes the fusing pad 34 (sliding sheet 35) across the fusing belt 31. The pressure roller 32 rotates about a rotation axis in a direction along the rotation axis of the fusing belt 31 and extends substantially in parallel with the fusing belt 31. The pressure roller 32 presses the fusing belt 31 against the fusing pad 34 (sliding sheet 35) to form a fusing nip FN between the pressure roller 32 and the fusing belt 31. Specifically, the pressure roller 32 has a configuration in which the surface of a cylindrical core material composed of a metal such as aluminum is covered with an elastic material such as rubber.

A driving force from a driving source (not illustrated), such as a motor, is transmitted to the pressure roller 32 via a gear or the like (not illustrated). The pressure roller 32 is rotationally driven by receiving this driving force, and the fusing belt 31 is driven to rotate in a direction opposite to the rotational direction of the pressure roller 32 in conjunction with the rotational driving of the pressure roller 32. That is, the pressure roller 32 is brought into contact with the outer circumferential surface of the fusing belt 31 to form the fusing nip FN, and the driving force is transmitted to the fusing belt 31 via the fusing nip FN. This causes the fusing belt 31 to be driven and rotated.

The temperature sensor 38 detects the surface temperature of the fusing belt 31. The temperature of the heat source 36 is controlled on the basis of the detected temperature.

The release plate 39 is disposed downstream of the fusing nip FN in the conveyance direction of the sheet P, and prevents the sheet P from being wound around the fusing belt 31.

Here, the installation procedure of the sliding sheet 35 will be described with reference to the drawings. FIG. 3A is a first process diagram illustrating a process of mounting the sliding sheet on the fusing pad of the image forming apparatus according to the first embodiment of the disclosure. FIG. 3B is a second process diagram illustrating a process of mounting the sliding sheet on the fusing pad of the image forming apparatus according to the first embodiment of the disclosure.

The process of mounting the sliding sheet 35 on the fusing pad 34 will be explained with reference to FIGS. 3A and 3B. The fusing pad. 34 is a long plate as described above, and the sliding sheet 35 is mounted on the surface of the fusing pad 34 adjacent to the fusing belt 31. The sliding sheet 35 has a fabric structure containing fluororesin fibers, and the surface of the sliding sheet 35 remote from the sliding contact surface 35a is bonded to the fusing pad 34 to fix the sliding sheet 35 to the fusing pad 34.

As illustrated in FIG. 3A, the sliding sheet 35 is pressed (thermally pressed) against the fusing pad 34 while being heated. The surface of the sliding sheet 35 to be bonded to the fusing pad 34 is provided with the adhesive layer 35b, The adhesive layer 35b may be composed of, for example, silicone rubber, and is preferably a material capable of heat welding.

Specifically, the sliding sheet 35 on which the adhesive layer 35b is formed is pressed against the fusing pad 34 while being heated to apply pressure from the surface remote from the adhesive surface of the sliding sheet 35 (the sliding contact surface 35a). The heating temperature, in this case, should be, for example, 200° C. or higher. The pressure applied to the sliding sheet 35 is preferably 1961330 pascal (20 kgfcm²) or more.

The sliding sheet 35 is adhered and fixed to the fusing pad 34, as illustrated in FIG. 3B, by pressing the sliding sheet 35 on which the adhesive layer 35b is formed to the fusing pad 34 while heating and applying pressure. This thereto-compresses the sliding sheet 35 to the fusing pad 34.

In thermo-compression, specifically, pressure is applied to the entire surface of the sliding sheet 35 from the sliding contact surface 35a side, for example, by a plate-like member, and the sliding sheet 35 is pressed against the fusing pad 34. As a result of the thermo-compression, the unevenness of the sliding contact surface 35a is reduced and flattened, and the surface roughness Ha of the sliding contact surface 35a is reduced. This improves the quality of the image formed on the sheet P in the image forming apparatus 100 including the fusing device 12. As described above, since the sliding sheet 35 is thereto-compressed to the fusing pad 34, fixing and mounting the sliding sheet 35 on the fusing pad 34 and reducing the surface roughness Ha of the sliding contact surface 35a of the sliding sheet 35 can be performed in the same process. This can simplify the manufacturing process and reduce the manufacturing cost.

When the pressure in the thermo-compression is increased, the surface roughness Ha of the sliding contact surface 35a is reduced, but when the unevenness is too small (the surface roughness Ha is too small), the holding force of the sliding oil on the sliding contact surface 35a is lowered. The surface roughness Ha of the sliding contact surface 35a is preferably 3 μm or more because the durability of the sliding sheet 35 is lowered when it becomes difficult to hold the sliding oil. In order to make the surface roughness Ha equal to or greater than 3 μm, it has been confirmed that the pressure applied to the sliding sheet 35 in thermo-compression is preferably equal to or less than 24516625 pascals (250 kgf/cm²).

When the sliding sheet 35 is thermo-compressed to the fusing pad 34, the adhesive layer 35b may seep out to the sliding contact surface 35a, and a material of the adhesive layer 35h may be formed on a portion of the sliding contact surface 35a. If the area of the portion from which the adhesive layer 35b has seeped out becomes too large, the sliding oil cannot be readily held on the sliding contact surface 35a. Thus, it is preferred that the amount of seeping of the adhesive layer 35b is small. An increase in the pressure during thermo-compression causes an increase in the amount of seeping of the adhesive layer 35b. Here, it has been confirmed that when the pressure applied to the sliding sheet 35 during thermo-compression becomes greater than 4903325 pascals (50 kgf/cm²), the adhesive layer 35b starts to seep into the g contact surface 35a.

In the thermo-compression, the pressure applied to the sliding sheet 35 is preferably 1961330 pascals (20 kgf/cm²) or more, more preferably 1961330 pascals (20 kgf/cm²) or more and 24516625 pascals (250 kgf/cm²) or less, more preferably 1961330 pascals (20 kgf/cm²) or more and 4903325 pascals (50 kgf/cm²) or less.

In thermo-compression, when the pressure applied to the sliding sheet 35 is 1.961330 pascals (20 kgf/cm²), the surface roughness Ra of the sliding sheet 35 is 19 μm, when the pressure is 4903325 pascals (50 kgf/cm²), the surface roughness Ra of the sliding sheet 35 is 1.7 μm, and when the pressure is 24516625 pascals (250 kgf/cm²), the surface roughness Ra of the sliding sheet 35 is 3 μm. In any of the cases, it has been confirmed that the image formed on the sheet P is of satisfactory quality, and the sliding sheet 35 has high durability. Thus, the surface roughness Ra of the sliding contact surface 35a of the sliding sheet 35 is preferably 19 μm or less, more preferably 19 μm or less and 3 μm or more, and more preferably 19 μm or less and 17 μm or more.

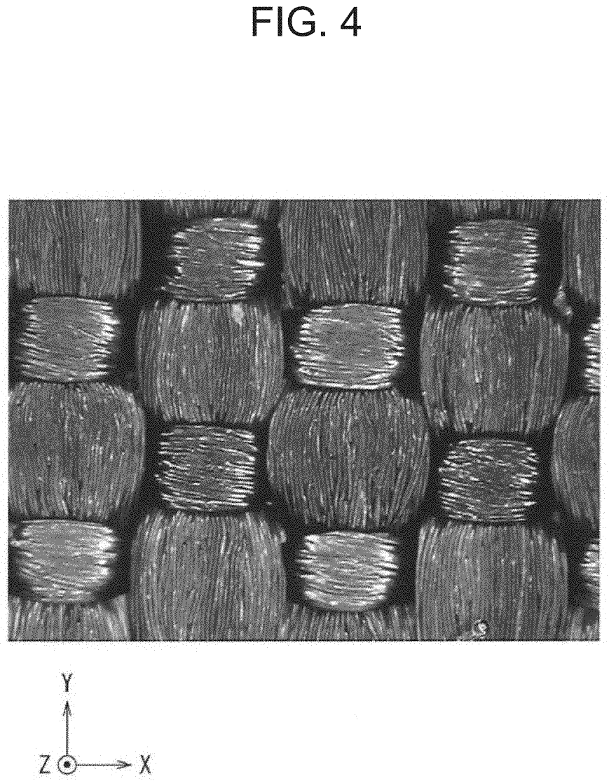

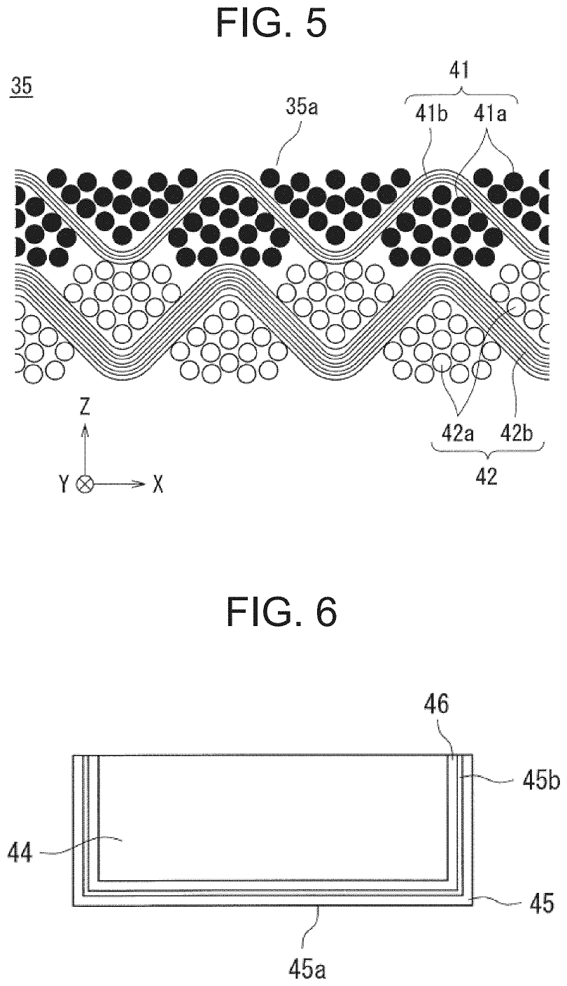

Now the composition of the sliding sheet 35 will be described with reference to the drawings. FIG. 4 illustrates an example of a surface of the sliding sheet according to the first embodiment of the disclosure. FIG. 5 is a schematic diagram illustrating a cross-section of the sliding sheet according to the first embodiment of the disclosure. In FIG. 4, the X-axis is the left-right direction of the paper surface, the Y-axis is the top-bottom direction of the paper surface, and the Z-axis is perpendicular to the paper surface. These directions of the XYZ axes also correspond to FIG. 5.

As illustrated in FIG. 4, the sliding sheet 35 is in the form of a woven fabric in which the PTFE fibers, which are fluororesin fibers, are woven in directions different from each other. In the sliding sheet 35 according to the first embodiment, PTFE fibers along the X-axis direction and PTFE fibers along the Y-axis direction are woven together. In other words, the directions of the fibers differ from each other by 90 degrees, but this angle is not limited to 90 degrees, as long as they form a fabric structure.

FIG. 5 schematically illustrates the cross-sectional structure of the sliding sheet 35 illustrated in FIG. 4. FIG. 5 is a diagram provided to facilitate the understanding of the configuration of the sliding sheet 35, which is a woven fabric, and schematically illustrates the configuration of the sliding sheet 35.

As illustrated in FIG. 5, PTFE fibers 41 include transverse fibers 41b in the fiber direction along the X-axis and longitudinal fibers 41a in the fiber direction along the Y-axis. The transverse fibers 41b and the longitudinal fibers 41a are woven. The sliding contact surface 35a is preferably composed of fluororesin fibers since releasing property is required, and is preferably composed of the PTFE fibers 41, but the components other than the sliding contact surface 35a may be composed of a material other than fluororesin fiber. The sliding sheet 35 of the first embodiment also has a fabric structure portion (a portion different from the sliding contact surface 35a) in which the polyphenylene sulfide (PPS) fibers 42 are woven in directions different from each other. Specifically, the PPS fibers 42 include transverse fibers 42b in the fiber direction along the X-axis and longitudinal fibers 42a in the fiber direction along the Y-axis. The transverse fibers 41b and the longitudinal fibers 41a are woven. In this way, the sliding sheet 35 has a woven fabric structure in which the PTFE fibers 41 and the PPS fibers 42 are integrated. Since the sliding sheet 35 is heated in the fusing device 12, the resin fibers constituting the sliding sheet 35 have heat resistance to the temperature to which the sliding sheet 35 is heated in the fusing device 12. For example, the sliding sheet 35 preferably has heat resistance that can withstand a temperature of 200° C. or higher and 250° C. or lower.

As described above, since the surface roughness Ra of the sliding contact surface 35a of the sliding sheet 35 of the first embodiment is small, the quality of the image formed on the sheet P is satisfactory. Since the sliding sheet 35 has high durability, the fusing device 12 and the image forming apparatus 100 can be operated for a long period of time. Since the manufacturing process can be simplified in the manufacturing of the fusing device 12, the manufacturing cost can be reduced.

### Second Embodiment

An image forming apparatus according to the second embodiment of the disclosure has the same configuration as that of the image forming apparatus 100 according to the first embodiment except that the fusing pad 34 and the sliding sheet 35 have different configurations. Therefore, these different points will be described with reference to the drawings, and the other configurations will not be repeated.

The configuration of the fusing pad and the sliding sheet of the image forming apparatus according to the second embodiment of the disclosure will be described with reference to the drawings, FIG. 6 is a schematic sectional view of the configuration of the fusing pad and the sliding sheet of the image forming apparatus according to the second embodiment of the disclosure.

As illustrated in FIG. 6, similar to the fusing pad 34 according to the first embodiment, a fusing pad 44 is composed of, for example, resin and is formed as a long plate extending along the rotation is direction of the fusing belt 31. A metal part 46 is disposed on the outer circumferential surface of the fusing pad 44 (the surface adjacent to the fusing belt 31 and the two side surfaces facing each other), and a sliding sheet 45 is disposed on the outer side of the metal part 46. The sliding sheet 45 is fixedly bonded to the metal part 46 via an adhesive layer 45b.

Although not illustrated, the fusing pad 44 is fixed such that the sliding sheet 45 is in sliding contact with the inner circumferential surface of the fusing belt 31. That is, the fusing pad 44 is disposed such that a sliding contact, surface 45a of the sliding sheet 45 is in contact with the inner circumference of the fusing belt 31. A sliding oil as a lubricant is applied to the sliding contact surface 45a of the sliding sheet 45 to reduce the frictional force with the fusing belt 31.

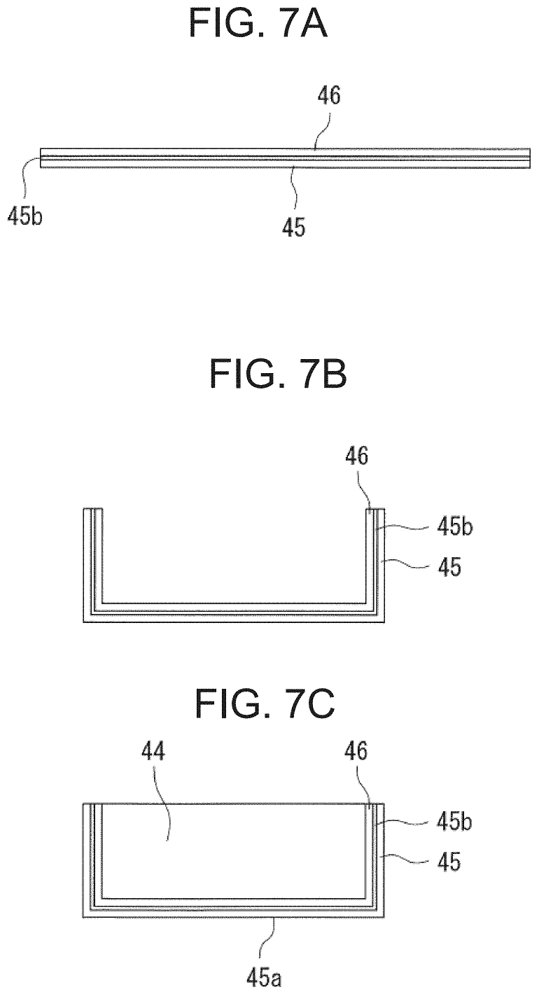

Here, the installation procedure of the sliding sheet 45 will be described with reference to the drawings. FIG. 7A is a first process diagram illustrating a process of mounting the sliding sheet on the fusing pad of the image forming apparatus according to the second embodiment of the disclosure. FIG. 7B is a second process diagram illustrating a process of mounting the sliding sheet on the fusing pad of the image forming apparatus according to the second embodiment of the disclosure. FIG. 7C is a third process diagram illustrating a process of mounting the sliding sheet on the fusing pad of the image forming apparatus according to the second embodiment of the disclosure.

The process of mounting the sliding sheet. 45 on the fusing pad 44 will be explained with reference to FIGS. 7A, 7B and 7C. The fusing pad 44 is a long plate as described above, and the sliding sheet 45 is mounted on the surface adjacent to the fusing belt 31 and the two surfaces facing each other via the metal part 46. The sliding sheet 45 is composed of the same material and has the same configuration as those of the sliding sheet 35 of the first embodiment, and has a fabric structure containing fluororesin fiber. The surface remote from the sliding contact surface 45a is bonded to the metal part 46, and the metal part 46 is fixed to the fusing pad 44 to fix the sliding sheet 45 to the fusing pad 44.

As illustrated in FIG. 7A, first, the sliding sheet 45 is disposed on the plate-like metal part 46 vis the adhesive layer 45b. The adhesive layer 45b is composed of the same material as the adhesive layer 35b of the first embodiment, for example, silicone rubber. The metal part 46, the adhesive layer 45b, and the sliding sheet 45 are stacked in this order, and placed in a mold and pressed to form the shape illustrated in FIG. 7B. The metal part 46, the adhesive layer 45b, and the sliding sheet 45 may be temporarily fixed so as to be integrated with each other before molding.

The metal part 46 and the sliding sheet 45 are fixedly bonded to each other via the adhesive layer 45b by thermo-compressing these through heating. That is, the metal part 46, the adhesive layer 45b, and the sliding sheet 45 are integrally formed while being molded by pressing and applying pressure while being heated. Since the sliding sheet 45 can be molded while being adhered to the metal part 46, the manufacturing process can be simplified and the manufacturing cost can be reduced. Since pressure is applied to the sliding sheet 45, the unevenness of the sliding contact surface 45a is reduced and flattened, and the surface roughness Ra of the sliding contact surface 45a is reduced. In this way, the quality of the image formed on the sheet P is improved. Thus, according to the second embodiment, the sliding sheet 45 can be molded while being bonded to the metal part 46, the surface roughness Ra of the sliding contact surface 45a can be reduced, and the fusing device 12 and the image forming apparatus 100 can be manufactured efficiently.

The pressure at the time of thermo-compression and the surface roughness Ra of the sliding contact surface 45a may be the same as those in the first embodiment.

The fusing pad 44 is fitted inside the metal part 46, which bonded to the sliding sheet 45 and molded, to fix the sliding sheet 45 to the fusing pad 44, as illustrated in FIG. 7C. The fusing pad 44 and the metal part 46 may be fixed by fitting, or may be fixed by screwing or other fixing means.

Since the fusing pad 44 is composed of resin as described above, there is a possibility that it may break by receiving strong pressure. However, according to the second embodiment, since the fusing pad 44 is simply fitted into the metal part 46 to which the sliding sheet 45 is bonded as described above, the sliding sheet 45 can be fixed and to the fusing pad. 44 without applying strong pressure to the fusing pad 44. The metal part 46 is less likely to break due to, for example, receiving pressure, and thus less likely to break during thermo-compression. The metal part 46 may be, for example, a copper plate or the like, or alternatively may be composed of metal besides copper.

Since the metal part 46 has high thermal conductivity, heat from the heat source 36 can efficiently transmitted, and the surface temperature of the fusing nip FN of the fusing belt 31 can be made uniform. Copper is particularly desirable as the metal part 46 because of its relatively high thermal conductivity.

As described above, since the surface roughness Ra of the sliding contact surface 45a of the sliding sheet 45 of the second embodiment is small, the quality of the image formed on the sheet P is satisfactory. Since the sliding sheet 45 has high durability, the fusing device 12 and the image forming apparatus 100 can be operated for a long period of time. Since the breakage of the fusing pad. 44 can be suppressed in the manufacturing of the fusing device 12, and the manufacturing process can be simplified, the manufacturing cost can be reduced. Furthermore, the surface temperature of the fusing nip FIN can be made uniform, which is preferable in image formation.

### OTHER EMBODIMENTS

In this first embodiment, the sliding sheet 35 is thermo-compressed to the fusing pad 34, and in this second embodiment, the sliding sheet 45 is thermo-compressed to the metal part 46, However, for example, the sliding sheet may be heated and subjected to pressure (thermal pressure) to reduce the surface roughness Ha of the sliding contact surface, and the sliding sheet 35 having reduced surface roughness Ha of the sliding contact surface may be fixed to the fusing pad. For example, the sliding sheet 35 may be fixed the fusing pad 34 by screwing or gluing.

Although the image forming apparatus according to the embodiments of the disclosure has been described above, the disclosure is not limited to the above-described embodiments and can be modified as appropriate.

The disclosure is not limited to the embodiments described above, but can be executed in various other forms. The foregoing embodiments are therefore to be considered in all respects illustrative rather than limiting. The scope of the disclosure is indicated by the appended claims, and is not bound in any way by the text of the specification. All modifications and variations that come within the equivalent scope of the claims are within the scope of the disclosure.

What is claimed is:

1. A sliding member having heat resistance, comprising:
a fabric structure containing fluororesin fiber,
the fluororesin fiber being flattened by thermal pressure and disposed on a sliding contact surface.

2. The sliding member according to claim 1, wherein a surface roughness Ra of the sliding contact surface is 19 μm or less.

3. A fusing device that thermally fuses a toner image formed on a recording medium, comprising:
a fusing rotary body;
a heat source that heats the fusing rotary body;
a pressurizing rotary body that comes into contact with an outer circumferential surface of the fusing rotary body to form a fusing nip between the fusing rotary body and the pressurizing rotary body, the pressurizing rotary body rotating the fusing rotary body;
a sliding member having a sliding contact surface, an inner circumferential surface of the fusing rotary body coming into contact and sliding on the sliding contact surface;
a fusing pad to which the sliding member is fixed; and
a support member that supports the fusing pad,
wherein the sliding member has a fabric structure containing fluororesin fiber, the fluororesin fiber flattened by thermal pressure is disposed on the sliding contact surface, and the sliding member has heat resistance.

4. The fusing device according to claim 3,
wherein the sliding member is thermo-compressed to the fusing pad via an adhesive layer.

5. The fusing device according to claim 3, further comprising:
a metal part disposed between the fusing pad and the sliding member,
wherein the sliding member is thermo-compressed to the metal part via an adhesive layer.

6. The fusing device according to claim 4,
wherein the adhesive layer is not provided on the sliding contact surface of the sliding member.

7. The fusing device according to claim 3, wherein a surface roughness Ra of the sliding contact surface of the sliding member is 19 μm or less.

8. An image forming apparatus comprising:
the fusing device according to claim 3.
